(19) United States
(12) Patent Application Publication
(10) Pub. No.: US 2025/0303611 A1
(43) Pub. Date: Oct. 2, 2025

(54) POTTERY TOOL

(71) Applicants: Karen Clark, Hendersonville, TN (US); Corey Clark, Hendersonville, TN (US)

(72) Inventors: Karen Clark, Hendersonville, TN (US); Corey Clark, Hendersonville, TN (US)

(21) Appl. No.: 18/618,756

(22) Filed: Mar. 27, 2024

(51) Int. Cl. B28B 7/28; B28B 1/02; B28B 7/38

(52) U.S. Cl. CPC B28B 7/28; B28B 1/02; B28B 7/388

(57) ABSTRACT

A pottery molding tool for creating a vessel, and a method of using the tool, are disclosed. The tool has a molding body having a first end and a second end and a generally circular cross-section between the first end and the second end. The body having a first diameter at the first end and a second diameter at the second end which is equal to or larger than the first diameter. A handle is formed at the second end and a handle base formed on the handle. The handle base configured to securely support the molding body and handle when the base is resting on a surface. The method includes forming the vessel on the molding body, rotating the tool to rest on the handle base, and removing the vessel formed on the molding body.

### BACKGROUND

Pottery as a hobby has a rich history that serves not only as a creative outlet but also as a means of personal expression. Among the most popular creations are handmade mugs, vases and drinkware which combine functionality with personal style. Drinkware can be more than just vessels for beverages; they are individual works of art that reflect the personality of the maker. Hobbyists across the nation take to pottery studios and workshops, finding joy in the tactile process of shaping, glazing, and firing clay.

### SUMMARY

One general aspect includes a molding body having a first end and a second end and a generally circular cross-section between the first end and the second end. The molding body has a first diameter at the first end and a second diameter at the second end. The molding body also includes a handle formed at the second end; and a handle base formed on the handle.

Implementations may include the tool where the tool is fabricated from one of: wood, metal, plastic. Implementations may include any of the foregoing tools wherein the handle base has a diameter sufficient to support the tool when resting on a surface when pottery clay is formed around the molding body. Implementations may include any of the foregoing tools wherein the second diameter is greater than the first diameter. Implementations may include any of the foregoing tools wherein a portion of the molding body has a generally linear section and another portion of the molding body has a curved section. Implementations may include any of the foregoing tools wherein the handle base has a diameter which is equal to or greater than the first diameter.

Another general aspect includes a method for creating a pottery vessel. The method also includes creating a vessel base on a surface using pottery clay. The method also includes placing a pottery tool including a molding body, handle and handle base, the molding body having a first end and a second end and a generally circular cross-section between the first end and the second end, on the vessel base such that the first end of the molding body engages the vessel base. The method also includes forming vessel walls of pottery clay around the molding body and engaging the vessel base. The method also includes rotating the tool 180 degrees and resting the rotated tool on the surface. The method also includes smoothing any junction in pottery clay between the vessel base and the vessel walls; and rotating the tool 180 degrees to remove the vessel from the tool.

Implementations may include the method where the tool includes a handle, and the rotating is performed using the handle. Implementations may include any of the foregoing methods wherein the tool includes a handle base, and the resting the tool includes resting the tool on the handle base. Implementations may include any of the foregoing methods wherein the method further includes applying a lubricant to the molding body prior to placing the pottery tool.

A further general aspect includes a pottery molding tool for creating a vessel. The pottery molding tool also includes a wood molding body having a first end and a second end and a generally circular cross-section between the first end and the second end, the body having a first diameter at the first end and a second diameter at the second end; a wood handle integrally formed at the second end, and a handle base integrally formed on the handle.

Implementations may include the tool where the handle base has a diameter sufficient to support the tool when resting on the surface when pottery clay is formed around the molding body. Implementations may include any of the foregoing tools wherein the tool is fabricated form one of wood, metal or plastic. Implementations may include any of the foregoing tools wherein the second diameter is greater than the first diameter. Implementations may include any of the foregoing tools wherein the molding body has a generally linear section between the first side and the second side. Implementations may include any of the foregoing tools wherein a portion of the molding body has a generally linear section and another portion of the molding body has a curved section.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a first perspective view of a first embodiment of a pottery tool.

FIG. 2 is a first side view of the first embodiment of a pottery tool.

FIG. 3 is a first end view of the first embodiment of a pottery tool.

FIG. 4 is a second end view of the first embodiment of a pottery tool.

FIG. 5 is a first perspective view of a second embodiment of a pottery tool.

FIG. 6 is a first side view of the second embodiment of a pottery tool.

FIG. 7 is a first end view of the second embodiment of a pottery tool.

FIG. 8 is a second end view of the second embodiment of a pottery tool.

FIG. 9 is a first perspective view of a third embodiment of a pottery tool.

FIG. 10 is a first side view of the third embodiment of a pottery tool.

FIG. 11 is a first end view of the third embodiment of a pottery tool.

FIG. 12 is a second end view of the third embodiment of a pottery tool.

FIG. 13 is a first perspective view of a fourth embodiment of a pottery tool.

FIG. 14 is a first side view of the fourth embodiment of a pottery tool.

FIG. 15 is a first end view of the fourth embodiment of a pottery tool.

FIG. 16 is a second end view of the fourth embodiment of a pottery tool.

FIG. 17 is a first perspective view of a fifth embodiment of a pottery tool.

FIG. 18 is a first side view of the fifth embodiment of a pottery tool.

FIG. 19 is a first end view of the fifth embodiment of a pottery tool.

FIG. 20 is a second end view of the fifth embodiment of a pottery tool.

FIG. 21 is a first perspective view of a sixth embodiment of a pottery tool.

FIG. 22 is a first side view of the sixth embodiment of a pottery tool.

FIG. 23 is a first end view of the sixth embodiment of a pottery tool.

FIG. 24 is a second end view of the sixth embodiment of a pottery tool.

FIG. 25 is a flowchart illustrating a method for using the tool in any of FIGS. 1-24.

FIG. 26 is a side view of pottery clay on a surface such as a table.

FIG. 27 is a side view of pottery clay on a surface such as a table with a pottery tool resting thereon.

FIG. 28 is a side view of pottery clay on a surface such as a table with drinkware walls formed around the tool.

FIG. 29 is a side view of the depiction of FIG. 28 rotated 180 degrees.

### DETAILED DESCRIPTION

A pottery tool and method for using the pottery tool to craft drinkware, vases, and other vessels is hereinafter described. Each of the various embodiments allows the creation of a vessel having a characteristic shape generally matching the molding body thereof, with the handle and handle base of each tool allowing manipulation of the vessel during creation of the pottery.

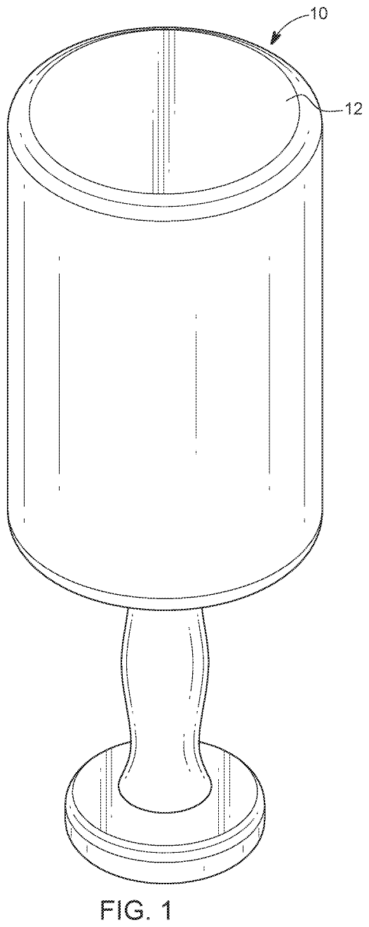

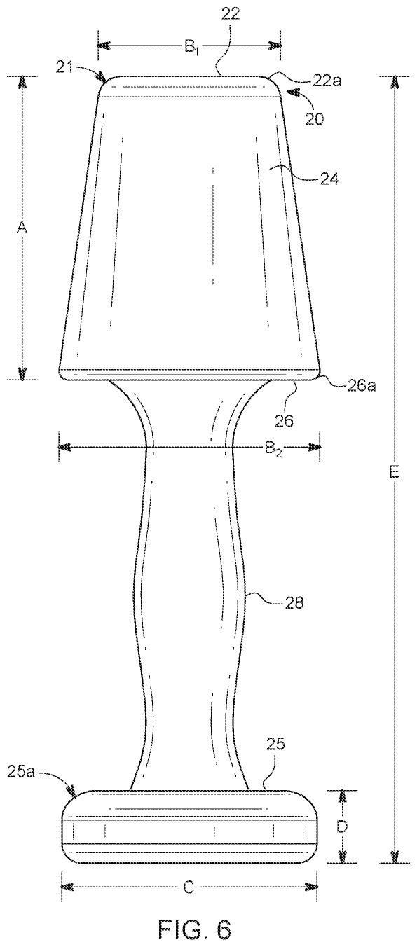

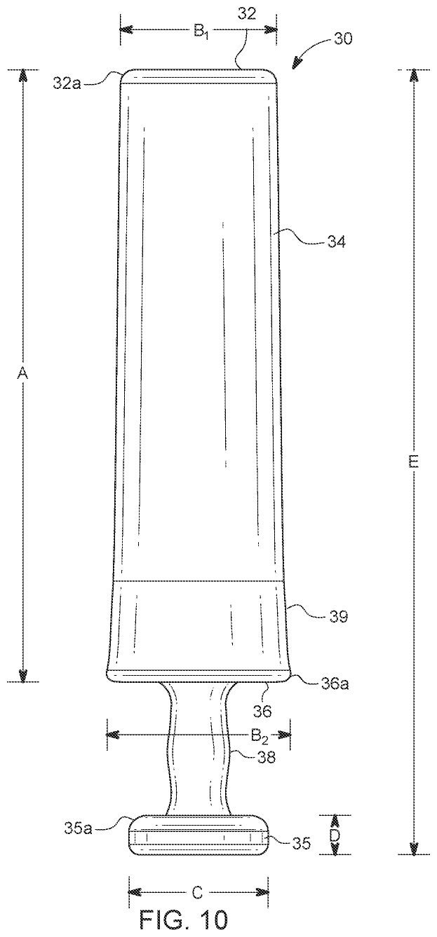

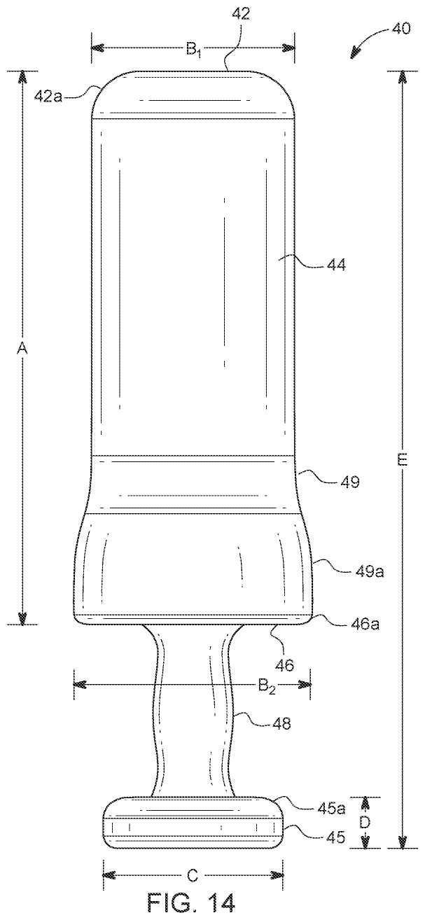

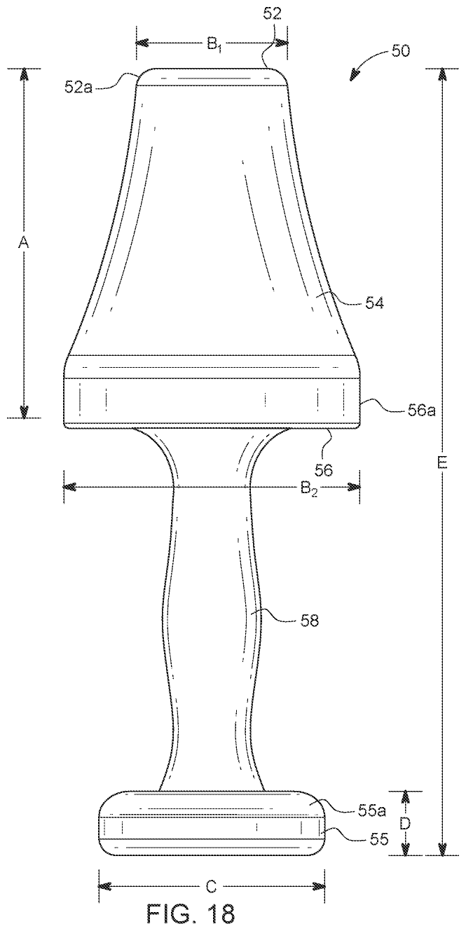

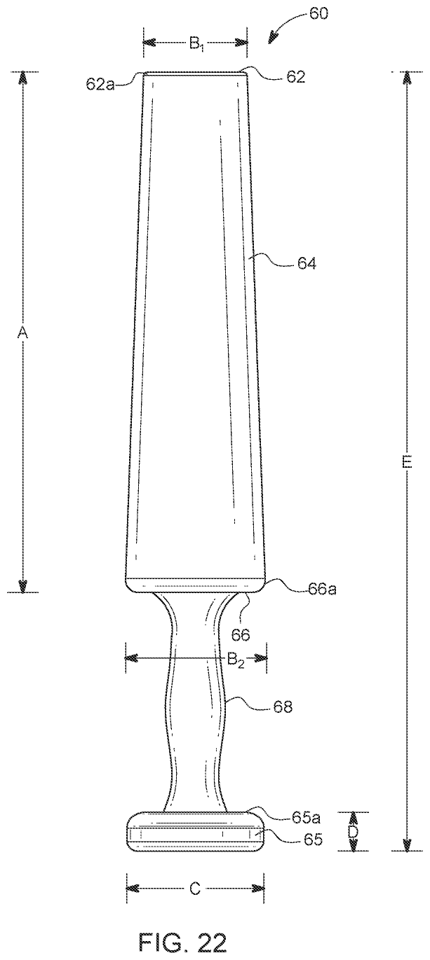

FIGS. 1-25 illustrate six embodiments of a pottery tool. Each of the tools 10, 20, 30, 40, 50, 60 includes a respective molding body 14, 24, 34, 44, 54, 65 and a respective handle 18, 28, 38, 48, 58, 68 with a respective handle base 15, 25, 35, 45, 55, 65 allowing the pottery tool to be used in at least two different directions. In embodiments, each of the tools 10, 20, 30, 40, 50, 60 described herein may be fabricated of wood, plastic, metal or any other suitable hardened material. In the following description, although the tool is primarily described with respect to wood embodiments, it should be understood that any of the aforementioned materials can be used.

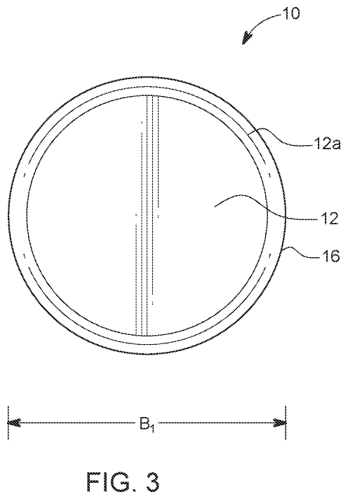

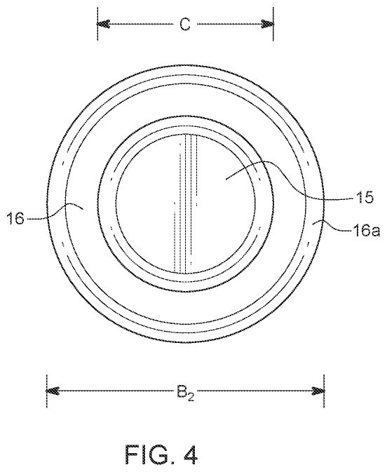

FIGS. 1-4 illustrate a first embodiment of a pottery tool suitable for use in forming a drinking vessel such as a mug or glass. Tool 10 includes a molding body 14 having a top surface 12, bottom surface 16, handle 18 and handle base 15. Tool 10 has a total height E comprising the combined heights of the molding body 14 (height A), handle 18 and handle base 15 (height D). The molding body 14 and handle base 15 have a circular cross section as illustrated in FIGS. 3 and 4, with one end of the molding body adjacent surface 12 having a diameter B1 and a second end of the molding body adjacent surface 16 having a diameter B2. The junction edge 12a between the side of the molding body and the 12 surface is formed at a radius, and the junction edge 16a between the side of the molding body and surface 16 has a radius. The diameters B1 and B2 differ slightly such that B1 is less than B2 providing a slight taper to the molding body 14. In tool 10, the side of the molding body between edge 12a and 16a is generally linear.

In the embodiment of FIG. 1, dimensions B1 and B2 may be as listed in Table 1:

| Embodiment | B1 | B2 |
|---|---|---|
| 2 | 2″ | 2⅛″ +/− ⅛″ |
| 214 | 2¼″ | 2 3/16″ +/− ⅛″ |
| 212 | 2½″ | 2⅝″ +/− ⅛″ |
| 234 | 2¾″ | 2⅞″ +/− ⅛″ |
| 3 | 3″ | 3⅛″ +/− ⅛″ |
| 314 | 3¼″ | 3 3/16″ +/− ⅛″ |
| 312 | 3½″ | 3⅝″ +/− ⅛″ |
| 358 | 3⅝″ | 3¾″ +/− ⅛″ |
| 334 | 3¾″ | 3⅞″ +/− ⅛″ |
| 4 | 4″ | 4⅛″ +/− ⅛″ |
| 2T | 2″ | 3″ +/− ⅛″ |
| 214T | 2¼″ | 3¼″ +/− ⅛″ |
| 212T | 2½″ | 3½″ +/− ⅛″ |
| 234T | 2¾″ | 3¾″ +/− ⅛″ |
| 3T | 3″ | 4″ +/− ⅛″ |

In embodiments, edge 12a is formed by a ¼″ radius and edge 16a is formed by a ⅛″ radius. Edge 15a may be formed by a 3/16″ radius. The total height E of tool 10 may be in a range of 10″-−18″ with one embodiment being 11¼″. The height A of the molding body may be between 5″ and 12″ with one embodiment being 5¾″. And the height D of handle base 15 may be between 1″ and 2″ with one embodiment being 11/4″. It should be understood that the aforementioned dimensions are exemplary and depend on the desired resulting vessel being formed. Handle base 15 has a circular cross section with a diameter C sized to be the same as or slightly less than diameter B1 but can be sized up to and even greater than diameter B2.

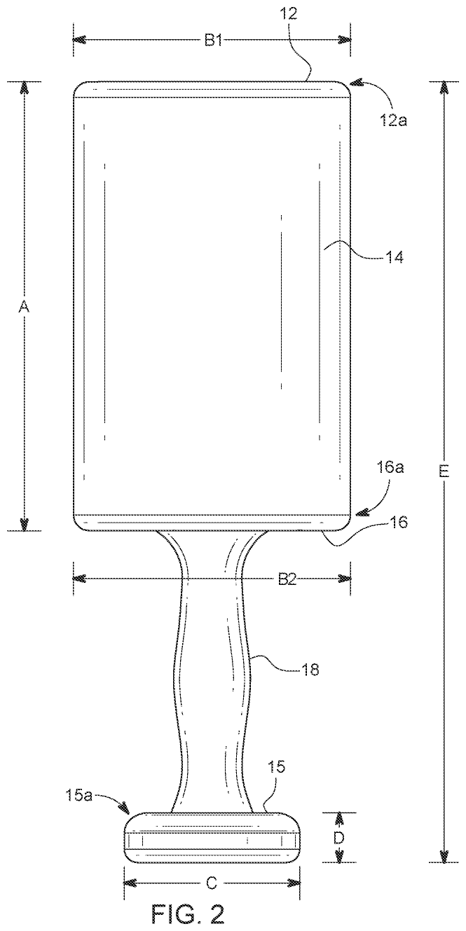

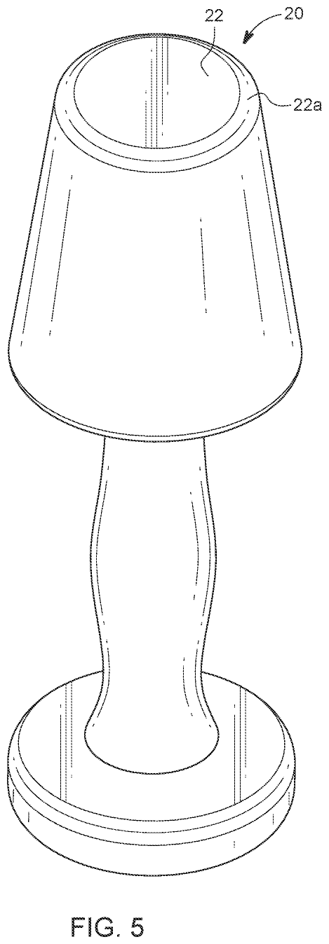

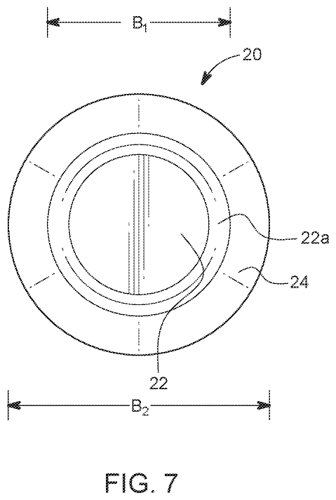

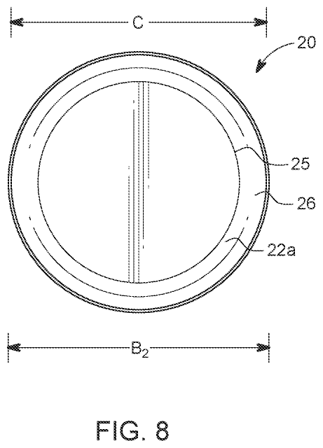

FIGS. 5-8 illustrate a second embodiment of a pottery tool 20 suitable for use in forming a drinking receptacle such as a mug or glass. In the embodiment of FIG. 2, B1 is much smaller than B2, resulting in a greater taper to the sides of the resulting vessel. In embodiments, B1 and B2 may be any respective distance depending on the shape of the vessel being formed. Tool 20 includes a molding body 24 having a top surface 22, bottom surface 26, handle 28 and handle base 25. Tool 20 has a total height E comprising the combined heights of the molding body 24 (height A), handle 28 and handle base 25 (height D). The molding body 24 and handle base 25 have a circular cross section as illustrated in FIGS. 7 and 8, with one end of the molding body adjacent surface 22 having a diameter B1 and a second end of the molding body adjacent surface 26 having a diameter B2. The junction edge 22A between the side of the molding body and the surface 22 is formed at a radius, and the junction edge 26a between the side of the molding body and surface 26 has a radius. In embodiments, edge 22a is formed by a ¼″ radius and edge 26a is formed by a ⅛″ radius. Edge 25a may be formed by a 3/16″ radius. In tool 20, the side of the molding body between edge 22a and 26a is generally linear. The total height E of tool 20 may be in a range of 11″-18″ with one embodiment being 11¼″. The height A of the molding body may be between 5″ and 12″ with one embodiment being 53/4″. And the height D of handle base 25 may be between 1″ and 2″ with one embodiment being 1¼″. It should be understood that the aforementioned dimensions are exemplary and depend on the desired resulting vessel being formed.

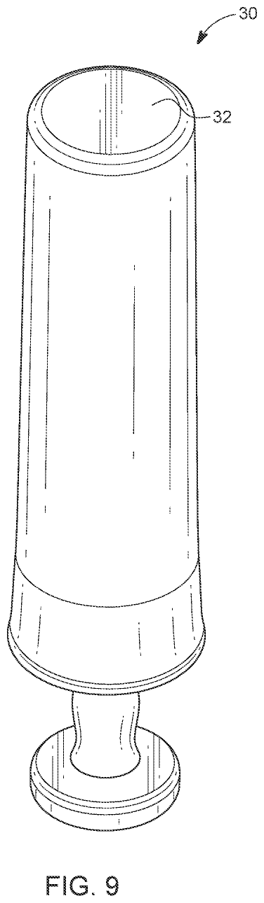

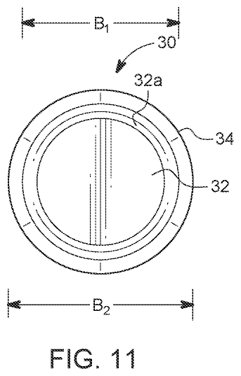

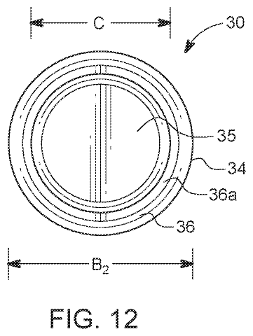

FIGS. 9-12 illustrate a third embodiment of a pottery tool suitable for use in forming a vessel such as a glass or vase. In the embodiment of FIG. 3, A is much longer than in the first or second embodiment, B1 is smaller than B2, and the molding body includes a flared section 39 where the diameter of the molding body increases at a greater rate to reach B2, resulting in a greater taper to the sides of the resulting vessel formed in region 39. In tool 30, the side of the molding body between edge 12a and region 39 is generally linear but need not be. In embodiments, B1 and B2 may be any respective distance depending on the shape of the vessel being formed. Tool 30 includes a molding body 34 having a top surface 32, bottom surface 36, handle 38 and handle base 35. Tool 30 has a total height E comprising the combined heights of the molding body 34 (height A), handle 38 and handle base 35 (height D). The molding body 34 and handle base 35 have a circular cross section as illustrated in FIGS. 11 and 12, with one end of the molding body adjacent surface 32 having a diameter B1 and a second end of the molding body adjacent surface 36 having a diameter B2. The junction edge 32A between the side of the molding body and the surface 32 is formed at a radius, and the junction edge 36a between the side of the molding body and surface 36 has a radius. In embodiments, edge 32a is formed by a ¼″ radius and edge 36a is formed by a ⅛″ radius. Edge 35a may be formed by a 3/16″ radius. The total height E of tool 30 may be in a range of 11″-18″ with one embodiment being 11¼″. The height A of the molding body may be between 5″ and 12″ with one embodiment being 5¾″. And the height D of handle base 35 may be between 1″ and 2″ with one embodiment being 1¼″. It should be understood that the aforementioned dimensions are exemplary and depend on the desired resulting vessel being formed.

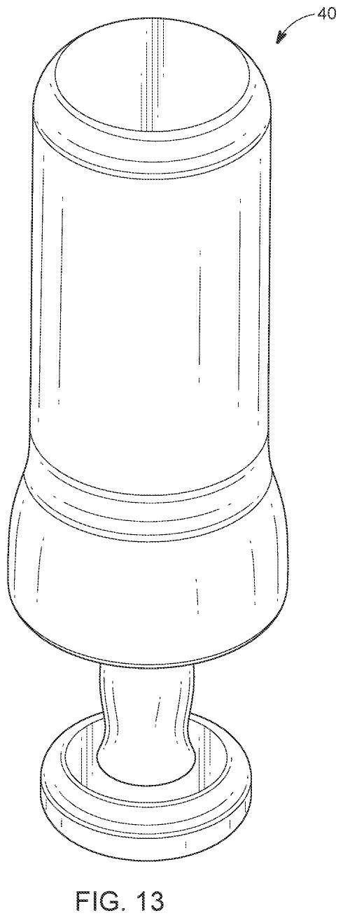

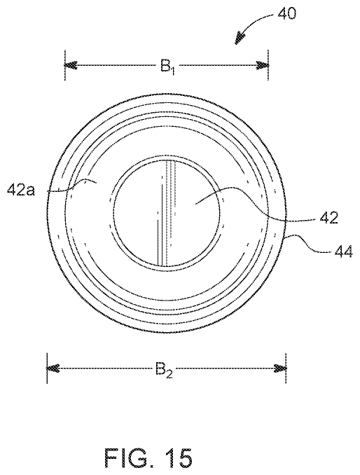

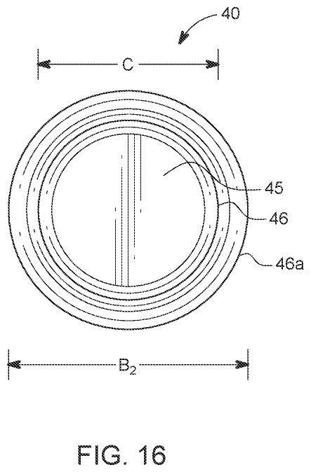

FIGS. 13-16 illustrate a fourth embodiment of a pottery tool 40 suitable for use in forming a vessel such as a glass or vase. In the embodiment of FIG. 13, A is much longer than in the first or second embodiment, B1 is smaller than B2, and edge 42A between surface 42 and body 44 has a much larger radius. The molding body 44 includes both a generally convex flared section 49b and indent (or transition) concave section 49a. The diameter of the molding body increases in section 49b to reach B2. Both sections 49a and 49b result in decorative features in the resulting vessel. In embodiments, B1 and B2 may be any respective distance depending on the shape of the vessel being formed. Tool 40 includes a molding body 44 having a top surface 42, bottom surface 46, handle 48 and handle base 45. Tool 40 has a total height E comprising the combined heights of the molding body 44 (height A), handle 48 and handle base 45 (height D). The molding body 44 and handle base 45 have a circular cross section as illustrated in FIGS. 15 and 16, with one end of the molding body adjacent surface 42 having a diameter B1 and a second end of the molding body adjacent surface 46 having a diameter B2. The junction edge 42a between the side of the molding body and the surface 42 is formed at a radius, and the junction edge 46a between the side of the molding body and surface 46 has a radius. In embodiments, edge 42a is formed by a ¼″ radius and edge 46a is formed by a ⅛″ radius. Edge 45a may be formed by a 3/16″ radius. The total height E of tool 40 may be in a range of 11″-18″ with one embodiment being 11¼″. The height A of the molding body may be between 5″ and 12″ with one embodiment being 5¾″. And the height D of handle base 45 may be between 1″ and 2″ with one embodiment being 1¼″. It should be understood that the aforementioned dimensions are exemplary and depend on the desired resulting vessel being formed.

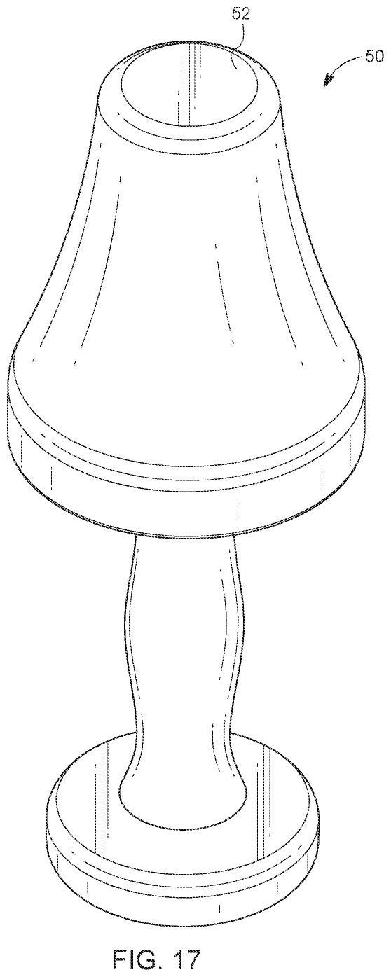

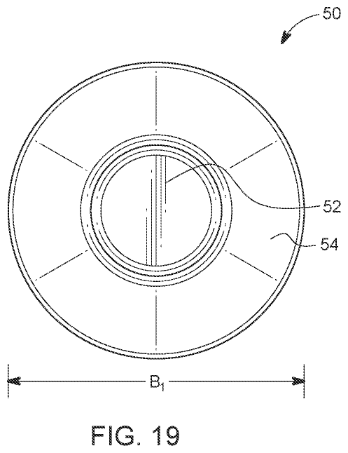

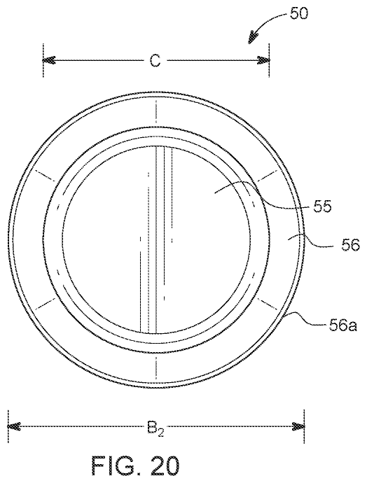

FIGS. 17-20 illustrate a fifth embodiment of a pottery tool 50 suitable for use in forming a vessel such as a glass or teacup. In the embodiment of FIG. 17, A is generally the same or shorter than in the first or second embodiment, B1 is much smaller than B2, and the molding body has a generally continuous (concave) taper between edge 52a and a transition section 59a, leading to a lip 59b which is adjacent surface 56. The generally convex section 59a yields a cup or vessel with a curved inner surface. The diameter of the molding body is generally constant in section 59b at B2. Both sections 59a and 59b result in decorative features in the resulting vessel. In embodiments, B1 and B2 may be any respective distance depending on the shape of the vessel being formed. Tool 50 includes a molding body 54 having a top surface 52, bottom surface 56, handle 58 and handle base 55. Tool 50 has a total height E comprising the combined heights of the molding body 54 (height A), handle 58 and handle base 55 (height D). The molding body 54 and handle base 55 have a circular cross section as illustrated in FIGS. 19 and 20, with one end of the molding body adjacent surface 52 having a diameter B1 and a second end of the molding body adjacent surface 56 having a diameter B2. The junction edge 52a between the side of the molding body and the surface 52 is formed at a radius, and the junction edge 56a between the side of the molding body and surface 56 has a radius. In embodiments, edge 52a is formed by a 3/16″ radius and edge 56a is formed by a ⅛″ radius. Edge 55a may be formed by a 3/16″ radius. The total height E of tool 50 may be in a range of 9″-12″ with one embodiment being 10¾″. The height A of the molding body may be between 5″ and 6″ with one embodiment being 5″. And the height D of handle base 55 may be between 1″ and 2″ with one embodiment being 1¼″. It should be understood that the aforementioned dimensions are exemplary and depend on the desired resulting vessel being formed.

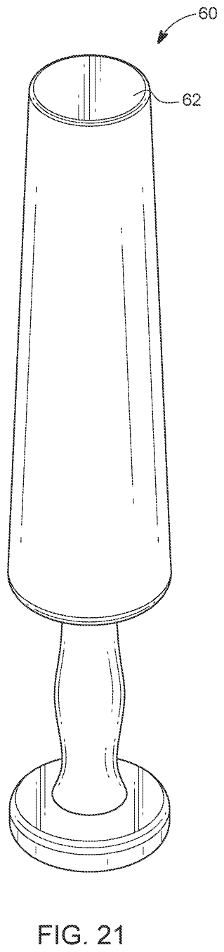

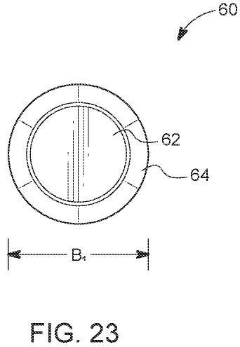

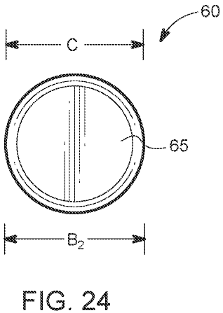

FIGS. 21-24 illustrate a sixth embodiment of a pottery tool 60 suitable for use in forming a vessel such as a glass or vase. In the embodiment of FIG. 21, height A is generally longer than in the first or second embodiment, B1 is smaller than B2, and the molding body has a generally continuous transition or taper between edge 62a and edge 66a. In embodiments, B1 and B2 may be any respective distance depending on the shape of the vessel being formed. Tool 60 includes a molding body 64 having a top surface 62, bottom surface 66, handle 68 and handle base 65. In tool 60, the side of the molding body between edges 62a and 66a is generally linear. Tool 60 has a total height E comprising the combined heights of the molding body 64 (height A), handle 68 and handle base 65 (height D). The molding body 64 and handle base 65 have a circular cross section as illustrated in FIGS. 23 and 24, with one end of the molding body adjacent surface 62 having a diameter B1 and a second end of the molding body adjacent surface 66 having a diameter B2. The junction edge 62a between the side of the molding body and the surface 62 is formed at a radius, and the junction edge 66a between the side of the molding body and surface 66 has a radius. In embodiments, edge 62a is formed by a 3/16″ radius and edge 66a is formed by a ⅛″ radius. Edge 65a may be formed by a 3/16″ radius. The total height E of tool 60 may be in a range of 11″-18″ with one embodiment being 15¼″. The height A of the molding body may be between 5″ and 12″ with one embodiment being 9¾″. And the height D of handle base 65 may be between 1″ and 2″ with one embodiment being 1¼″. It should be understood that the aforementioned dimensions are exemplary and depend on the desired resulting vessel being formed.

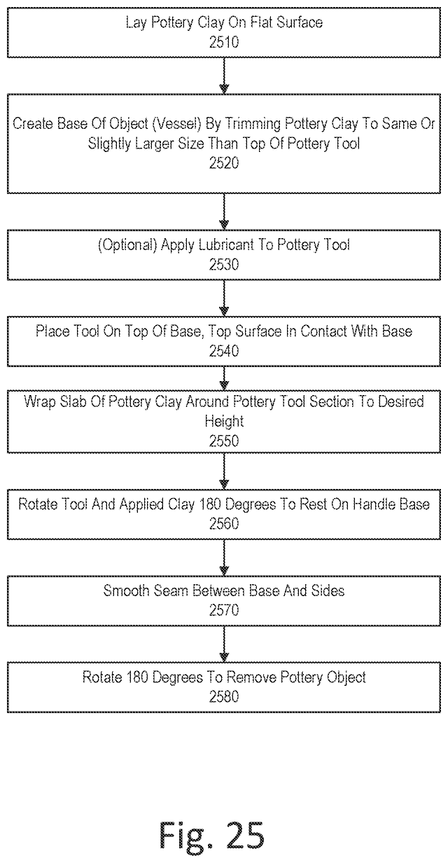

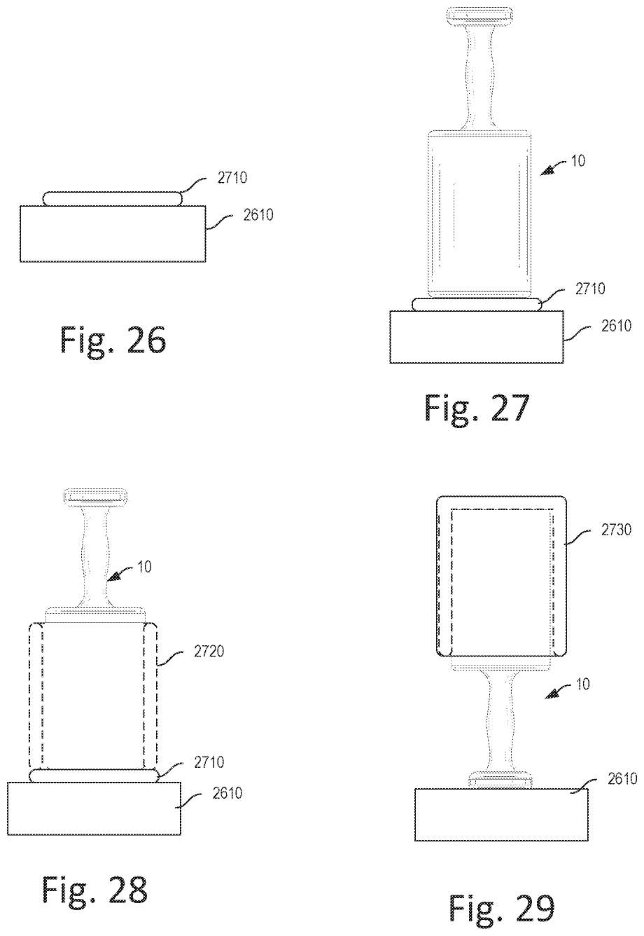

FIG. 25 is a flowchart illustrating a method of using any of the embodiments of the tool disclosed herein. FIGS. 26-29 illustrate some of the steps of FIG. 25.

At step 2510, a portion of pottery clay 2710 is formed on a flat surface such as a table 2610. At 2520, the clay is formed to a size of the desired base of a vessel being formed as illustrated at FIG. 26. The size may be the same as diameter B1 of the tool being used or may be larger by a factor sufficient to form a base for the sides of the vessel which are later formed on the molding base. Optionally, at step 2530, a lubricant is then applied to the pottery tool. In one embodiment, the lubricant may be a dry lubricant such as cornstarch. At 2540, a tool is placed on top of the base clay 2710 as illustrated in FIG. 27 with the side of the molding body of the tool resting on the clay. In the example shown in FIG. 27, side 12 of tool 10 rests on claim 2710. At 2550, clay is wrapped around the molding body of the tool to form walls 2720 of the vessel as illustrated in FIG. 28, Portions of the walls 2720 will engage the base clay 2710. At 2760, the tool is rotated 180 degrees (i.e. vertically flipped, upside down) with the clay attached as illustrated in FIG. 29. At 2570, any seam between the base 2710 and sides 2720 are smoothed to create a seam free vessel 2730. It will be understood that step 2570 may precede step 2560, and/or that smoothing may occur both before and after rotation of the tool. At this point, any handle or other decorative elements of the vessel may be added. At 2580, the tool is once again rotated 180 degrees to remove the vessel from the tool.

In other embodiments, the molding body need not have a circular cross section, but may have a square, triangular, rectangular or other geometric shaped cross-section.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I (we) claim:

1. A pottery molding tool for creating a vessel, comprising:
a molding body having a first end and a second end and a generally circular cross-section between the first end and the second end, the body having a first diameter at the first end and a second diameter at the second end which is equal to or larger than the first diameter;
a handle formed at the second end; and
a handle base formed on the handle, the handle base configured to securely support the molding body and handle when the base is resting on a surface.

2. The tool of claim 1 wherein the tool is fabricated from one of: wood, metal, plastic.

3. The tool of claim 1 wherein the handle base has a disk shape with a diameter sufficient to support the tool when resting on a surface when pottery clay is formed around the molding body.

4. The tool of claim 1 wherein the second diameter is greater than the first diameter.

5. The tool of claim 1 wherein the molding body has a generally linear section between the first side and the second side.

6. The tool of claim 1 wherein a portion of the molding body has a generally linear section and another portion of the molding body has a curved section.

7. The tool of claim 1 wherein the handle base has a diameter which is equal to or greater than the first diameter.

8. A method for creating a pottery vessel, comprising:
creating a vessel base on a surface using pottery clay;
placing a pottery tool including a molding body, handle and handle base, the molding body having a first end and a second end and a generally circular cross-section between the first end and the second end, on the vessel base such that the first end of the molding body engages the vessel base;
forming vessel walls of pottery clay around the molding body and engaging the vessel base;
rotating the tool 180 degrees and resting the rotated tool on the handle base on a surface;
smoothing any junction in pottery clay between the vessel base and the vessel walls; and
rotating the tool 180 degrees to remove the vessel from the tool, the handle base configured to securely support the molding body and handle when the base is resting on a surface.

9. The method of claim 8 wherein the tool includes a handle, and the rotating is performed using the handle.

10. The method of claim 8 wherein the tool includes a handle base, and the resting the tool includes resting the tool on the handle base.

11. The method of claim 8 wherein the method further includes applying a lubricant to the molding body prior to placing the pottery tool.

12. A pottery molding tool for creating a vessel, comprising:
a wood molding body having a first end and a second end and a generally circular cross-section between the first end and the second end, the body having a first diameter at the first end and a second diameter at the second end;
a wood handle integrally formed at the second end; and
a handle base integrally formed on the handle the handle base configured to securely support the molding body and handle when the base is resting on a surface.

13. The tool of claim 12 wherein the handle base has a disk shape with a diameter sufficient to support the tool when resting on a surface when pottery clay is formed around the molding body.

14. The tool of claim 12 wherein the tool is fabricated from one of: wood, metal, plastic.

15. The tool of claim 13 wherein the second diameter is greater than the first diameter.

16. The tool of claim 15 wherein the molding body has a linear section between the first side and the second side.

17. The tool of claim 15 wherein a portion of the molding body has a generally linear section and another portion of the molding body has a curved section.

18. The tool of claim 12 wherein the handle base has a diameter which is equal to or greater than the first diameter.
